(19) United States
(12) Patent Application Publication
(10) Pub. No.: US 2022/0074844 A1
(43) Pub. Date: Mar. 10, 2022

(54) PARTICLE IMAGING

(71) Applicant: Hewlett-Packard Development Company, L.P., Spring, TX (US)

(72) Inventors: Fausto D'Apuzzo, Palo Alto, CA (US); Viktor Shkolnikov, Palo Alto, CA (US); Yang Lei, Palo Alto, CA (US)

(73) Assignee: Hewlett-Packard Development Company, L.P., Spring, TX (US)

(21) Appl. No.: 17/298,481

(22) PCT Filed: May 30, 2019
(86) PCT No.: PCT/US2019/034753

§ 371 Date: May 28, 2021

(51) Int. Cl. G01N 15/14

(52) U.S. Cl. CPC G01N 15/1429; G01N 2015/0073; G01N 2015/1443; G01N 2015/1445

(57) ABSTRACT

A particle imaging system may include a volume to contain a fluid having a suspended particle, electrodes proximate to the volume to apply an electric field to rotate the suspended particle, an optical sensor comprising a first region and a second region and a diffraction element to split an image of the suspended particle into a bright field image focused on the first region and a spectral image focused on the second region.

### BACKGROUND

Particles are sometimes imaged to identify the particles or characteristics of the particles. For example, cellular structures such as cells, 3D cultures and organoids may serve as a key to understanding cellular mechanisms and processes. Such cellular structures are sometimes modeled or reconstructed to facilitate further study of such cellular structures.

### BRIEF DESCRIPTION OF THE DRAWINGS

FIG. 1 is a schematic diagram illustrating portions of an example particle imaging system.

FIG. 2 is a schematic diagram illustrating portions of an example particle imaging system.

FIG. 3 is a flow diagram of an example three-dimensional volume imaging method.

FIG. 4 is a diagram schematically illustrating capture of two-dimensional image frames of a rotating object at different angles.

FIG. 5 is a diagram depicting an example image frame including the identification of features of a particle at a first angular position.

FIG. 6 is a diagram depicting an example image frame including the identifications of the features of the particle at a second different angular position.

FIG. 7 is a diagram illustrating triangulation of the different identified features for the merging and alignment of features from the frames.

FIG. 8 is a diagram illustrating an example three-dimensional volumetric parametric model produced from the example image frames including those of FIGS. 5 and 6.

FIG. 9 is a flow diagram illustrate portions of an example particle imaging method.

FIG. 10 is a sectional view schematically illustrating portions of an example particle imaging system.

FIG. 11A is a top view of portions of an example diffraction element.

FIG. 11B is an enlarged top view of portions of the diffraction element of FIG. 11A.

FIG. 11C is a perspective view of the diffraction element of FIG. 11B.

FIG. 12 is a top view of portions of an example diffraction element.

FIG. 13A is a top view schematically illustrating portions of an example particle imaging system.

FIG. 13B is a sectional view schematically illustrating portions of the example particle imaging system of FIG. 13A.

FIG. 14 is a sectional view schematically illustrating portions of an example particle imaging system.

FIG. 15 is a sectional view schematically illustrating portions of an example particle imaging system.

Throughout the drawings, identical reference numbers designate similar, but not necessarily identical, elements. The FIGS. are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example particle imaging systems, methods and machine-readable mediums that facilitate the imaging of particles such as biological and non-biological particles. The example particle imaging systems, methods and machine readable mediums may be well-suited to the imaging of biological particles in the form of cellular structures such as cells, 3D cultures and organoids. The example particle imaging systems, methods and machine readable mediums facilitate the construction of 3D images of the particles to facilitate identification or further study of the particles.

The example particle imaging systems, methods and machine-readable mediums utilize electrodes to apply an electric field that rotates a suspended particle. A diffraction element splits an image of the suspended particle into a brightfield image focused on a first region of an optical sensor and a spectral image focused on a second region of the optical sensor. The brightfield image and the spectral image may be combined to form an enhanced 3D volumetric image of the particle. A volumetric image may depict internal structures within the particle.

For purposes of this disclosure, a “bright field image” is an image where a specimen, a particle or components of a particle in the described implementations, appear darker or have varying degrees of darkness on a bright background or bright field of view. A “spectral image” is an image formed by multispectral imaging or hyperspectral imaging. A spectral image is an image formed by spectroscopic data, identifying visible and non-visible bands of electromagnetic wavelengths, simultaneously and independently. In some implementations, the different bands may be different colors of visible light.

For purposes of this disclosure, a “diffraction element” refers to an optical device that receives or captures an image and splits the image into a brightfield image focused onto a first location and a spectral image focused on to a second different location. In some implementations, the diffraction element may produce multiple spectral images that are focused on to multiple different locations separate from the location of the brightfield image. In some implementations, the diffraction element may have a phase profile that includes an axial focus to focus the brightfield image and an oblique focus to focus the spectral image. In one implementation, the oblique focus may have a lateral offset that increases with increasing wavelength. In one implementation, the diffraction may comprise a planar diffraction element selected from a group of planar diffraction elements consisting of a multifocal lens and a grating. In some implementations, the diffraction element is selected from a larger group of diffraction elements consisting of a multifocal lens, a grating and a prism. In yet other implementations, the diffraction element may comprise a multifocal lens selected from a group of multifocal lenses consisting of a meta lens and a zone plate.

The example particle imaging systems, methods and machine-readable mediums may utilize the brightfield image, the spectral image or the 3D image generated from the combination of the brightfield image and spectral image to further process the particle. For example, such information regarding the particle may be utilized to identify or classify the particle. In some implementations, the identification or classification of the particle may be further used to selectively deposit and identified particle or a classified particle into a particular well of a multi well plate for subsequent analysis. The example particle imaging systems, methods and machine-readable mediums facilitate the simultaneous capture of 3D morphological and multispectral images of particles to classify, identify and/or process large numbers of particles or cells in a more efficient manner.

Disclosed is an example particle imaging system that may include a volume to contain a fluid having a suspended particle, electrodes proximate to the volume to apply an electric field to rotate the suspended particle, an optical sensor comprising a first region and a second region and a diffraction element to split an image of the suspended particle into a brightfield image focused on the first region and a spectral image focused on the second region.

Disclosed is an example particle imaging method. The method may include applying an electric field to a particle suspended in a fluid to rotate the suspended particle, splitting an image of the rotating suspended particle into a brightfield image focused on a first region of an optical sensor and a spectral image focused on a second region of an optical sensor and constructing a 3D volumetric image of the rotating suspended particle based upon a combination of the brightfield image and the spectral image as sensed by the optical sensor.

Disclosed is an example non-transitory machine-readable or computer-readable medium that contain instructions for a processor. The instructions may include particle rotation instructions and imaging instructions. The particle rotation instructions are to direct the processor to electrically charge electrodes to apply an electric field to rotate a particle suspended in a fluid. The imaging instructions are to direct the processor to construct a 3D image of the particle, during rotation of the particle, from a combination of a brightfield image of the rotating suspended particle and a spectral image of the rotating suspended particle concurrently sensed.

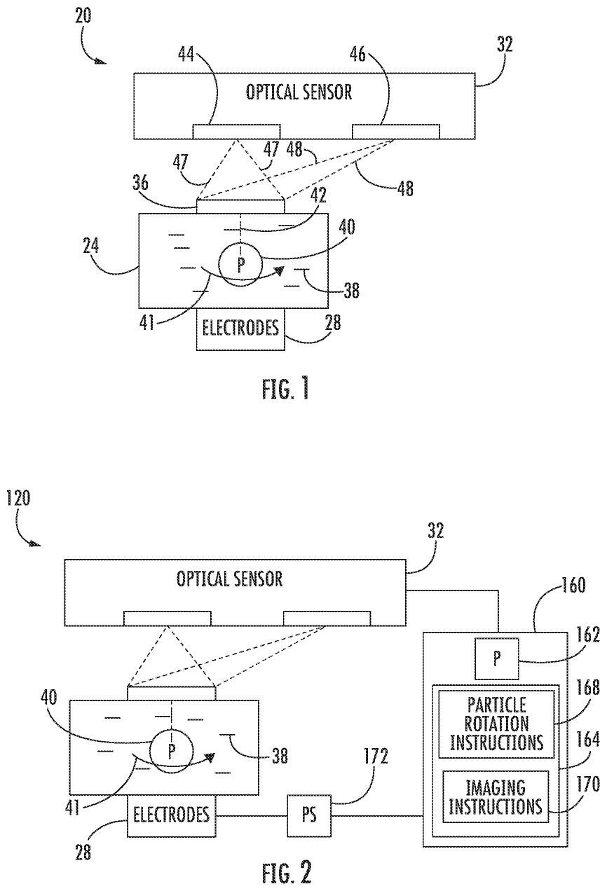

FIG. 1 schematically illustrates portions of an example particle imaging system 20. Imaging system 20 may be well-suited to the imaging of biological particles in the form of cellular structures such as cells, 3D cultures and organoids. Imaging system 20 facilitates the construction of 3D volumetric images of the particles to facilitate identification of further study of the particles. Imaging system 20 applies an electric field to rotate a suspended particle. A diffraction element splits an image of the suspended particle into a brightfield image focused on a first region of an optical sensor and a spectral image focused on a second region of the optical sensor. The brightfield image provides morphological (shape) information regarding the particle. The spectral components provided in the spectral image may facilitate the depiction and identification of internal structures of the particle. The brightfield image and the spectral image may be subsequently combined to form an enhanced 3D volumetric image of the particle. Imaging system 20 comprises volume 24, electrodes 28, optical sensor 32 and diffraction element 36.

Volume 24 comprises a chamber, channel, flow passage or other space to contain a fluid 38 in which a particle, biological or non-biological, may be suspended. In one implementation, at least portions of the volume 24 comprise a transparent portion through which light reflected from the suspended particle may pass to and through diffraction element 36. In one implementation, the diffraction element 36 may form a portion of a wall forming volume 24.

Electrodes 28 comprise electrically conductive members sufficiently proximate to volume and connected to or connectable to a source of electrical power. Two of the electrodes 28 are connected to or are connectable to different charges such that an electric field is formed between the electrodes. The electrodes 28 are sufficiently proximate to volume 24 such that the electric field is located within volume 24 and is sufficiently strong and controlled at a particular frequency so as to rotate the suspended particle 40 (schematically illustrated) as indicated by arrow 41. In one implementation, electrodes 28 provide electro-kinetic rotation. In one implementation, electrodes 28 are electrically charged so as to apply a nonrotating nonuniform electric field so as to apply a dielectrophoretic torque to the particle 40 is to rotate the particle 40 while the particle 40 is suspended in fluid 38.

In one implementation, the nonrotating nonuniform electric field is an alternating current electric field having a frequency of at least 30 kHz and no greater than 500 kHz. In one implementation, the nonrotating nonuniform electric field has a voltage of at least 0.1 V rms and no greater than 100 V rms. Between taking consecutive images with sensor 32, the particle may be rotated a distance that at least equals to the diffraction limit dlim of the imaging optics, such as diffraction element 36. The relationship between minimum rotating angle θmin, radius r and diffraction limit distance dlim is θmin=dlim/r. For example, for imaging with light of λ=500 nm and a diffraction element 36 of 0.5 numerical aperture (NA), the diffraction limit dlim=λ/(2NA)=500 nm. In the meanwhile, the particle 40 may not rotate too much that there is no overlap between consecutive image frames. In one implementation, the maximum rotating angle between consecutive images θmax=180−θmin. In one implementation, the nonuniform nonrotating electric field produces a dielectrophoretic torque on the particle so as to rotate the particle at a speed such that the optical sensor 32 may capture images every 2.4 degrees while producing output in a reasonably timely manner. In one implementation where the capture speed of the optical sensor 32 is 30 frames per second, the produced dielectrophoretic torque rotates the particle at a rotational speed of at least 12 rpm and no greater than 180 rpm. In one implementation, the produced dielectrophoretic torque rotates the particle at least one pixel shift between adjacent frames, but where the picture shift is not so great so as to not be captured by the optical sensor. In other implementations, particle 40 may be rotated at other rotational speeds.

Optical sensor 32 comprises an image sensor that detects light so as to form an image of particle 40. In one implementation, optical sensor 32 comprises a CMOS array having multiple pixels. In other implementations, of sensor 32 may comprise other image sensors such as charge coupled devices CCDs. As schematically shown by FIG. 1, optical sensor 32 comprises a first region 44 and a second region 46. Regions 44 and 46 received different images of particle 40 output by diffraction element 36. The signals from the different regions 44 and 46 may be stored or transmitted to an image generator that combines the different images into a three-dimensional volumetric image of particle 40.

Diffraction element 42 comprises an optical member that splits an optical image of particle 40 into a brightfield image which is focused on region 44 as indicated by broken lines 47 and a spectral image which is focused on the region 46 as indicated by broken lines 48. In some implementations, the diffraction element 36 may have a phase profile that includes an axial focus to focus the brightfield image and an oblique focus to focus the spectral image. In one implementation, the oblique focus may have a lateral offset that increases with increasing wavelength. In one implementation, the diffraction element 36 may comprise a planar diffraction element selected from a group of planar diffraction elements consisting of a multifocal lens and a grating. In some implementations, the diffraction element 36 is selected from a larger group of diffraction elements consisting of a multifocal lens, a grating and a prism. In yet other implementations, the diffraction element 36 may comprise a multifocal lens selected from a group of multifocal lenses consisting of a meta lens and a zone plate.

FIG. 2 schematically illustrates portions of an example particle imaging system 120. Imaging system 120 is similar to imaging system 20 described above except that imaging system 120 additionally comprises image generator 160 and electrical power source 172. Those remaining components of system 120 which correspond to components of system 20 are numbered similarly.

Image generator 160 controls the application of electric field in the corresponding rotation of particle 40. Image generator 160 further receives the signals from the different regions 44, 46 of optical sensor 32 and uses such signals, representing the brightfield image and the spectral image, to form a three-dimensional volumetric image of particle 40. Although system 120 is illustrated as combining both particle rotation and imaging in a single unit, in other implementations, such functions may be distributed amongst separate units. Image generator 160 comprises processor 162 and machine readable instructions 164.

Processor 162 comprises a processing unit that carries out instruction contained on medium 164. For purposes of this disclosure, reference to a single element or component, such as “a processing unit”, shall encompass multiples of such elements or components, unless otherwise specifically noted.

Machine-readable instructions 164 comprise software, code, programming or the like for directing a machine, such as a computer, to carry out certain actions or functions. The instructions 164 comprise particle rotation instructions 168 and imaging instructions 170. Particle rotation instructions 168 instruct processor 162 to control the supply of power from a power source 172 to electrodes 28 to control the electric field produced by electrodes 28 which controls the rotation of particle 40.

In one implementation, the nonrotating nonuniform electric field is an alternating current electric field having a frequency of at least 30 kHz and no greater than 500 kHz. In one implementation, the nonrotating nonuniform electric field has a voltage of at least 0.1 V rms and no greater than 100 V rms. Between taking consecutive images with sensor 32, the particle may be rotated a distance that at least equals to the diffraction limit dlim of the imaging optics, such as diffraction element 36. The relationship between minimum rotating angle θmin, radius r and diffraction limit distance dlim is θmin=dlim/r. For example, for imaging with light of λ=500 nm and a diffraction element 36 of 0.5 numerical aperture (NA), the diffraction limit dlim=λ/(2NA)=500 nm. In the meanwhile, the particle 40 may not rotate too much that there is no overlap between consecutive image frames. In one implementation, the maximum rotating angle between consecutive images θmax=180−θmin. In one implementation, the nonuniform nonrotating electric field produces a dielectrophoretic torque on the particle so as to rotate the particle at a speed such that the optical sensor 32 may capture images every 2.4 degrees while producing output in a reasonably timely manner. In one implementation where the capture speed of the optical sensor 32 is 30 frames per second, the produced dielectrophoretic torque rotates the particle at a rotational speed of at least 12 rpm and no greater than 180 rpm. In one implementation, the produced dielectrophoretic torque rotates the particle at least one pixel shift between adjacent frames, but where the picture shift is not so great so as to not be captured by the optical sensor. In other implementations, particle 40 may be rotated at other rotational speeds.

Imaging instructions 170 direct processor 162 to retrieve or receive signals representing the brightfield image and the spectral image from optical sensor 32. Imaging instructions 170 further process such data to combine the brightfield image and the spectral image so as to form a three-dimensional volumetric image of the particle 40. With respect to biological particles, such as cells, the brightfield image may depict cell morphology. The spectral image may place images of differently colored structures at different positions in the cell. In some implementations, two structures lying on top of each other within the cell may be dyed with different dies to facilitate discrimination in the spectral image. Imaging instructions 170 direct processor 162 to carry out a reconstruction that takes a series of both morphological and spectral images of the rotating cell to reconstruct a 3D image which contains both morphological (3D shape) and spectral (color of the stain, therefore type of cellular structure) information. Examples of different types of cellular structures which may be identified from the spectral image include, but are not limited to, the membrane, nucleus and lysosome of the cell.

In one implementation, the 3D image is constructed by initially calibrating the image path for the bright field image and the spectral image. Such a calibration step may yield two types of information: a transform function f_{optics} of the optical system including the shift offset a certain wavelength input and a point spread function, F_{psd} at the same wavelength input. Such calibration should be done for a range of wavelengths of interest. Using the results of the calibration, a physical model of the forward image process may be obtained. For example, given a cells 3D volume V and a stain color wavelength λ, images may be observed at an angle θ:

I₁(θ)=f_{optics1}(V)*f_{psd1}

I₂(θ)=f_{optics2}(V, λ)*f_{psd2}(λ)

Once the calibration has been completed, three 3D image of particles 40 may be constructed according to the following protocol:
1. analyze the dual-foci (spatial and spectral) image pairs and calculate the offset of the same structure between the two images. Then combined with transform function f_{optics} obtained in the calibration step, the color information (types of structures) can be restored in both spatial and spectral images. Each color represents one type of structure;
2. take the restored color information from previous step, segment cellular structures based on color in the undistorted spatial image sequence. Separate all structures by color if overlapping;
3. analyze the image sequences and select images for one complete revolution; and
4. take the centroids of structures from images of one complete revolution, matching the same structure in consecutive frames, and reconstruct 3D shape of each structure, i.e. the morphological information.

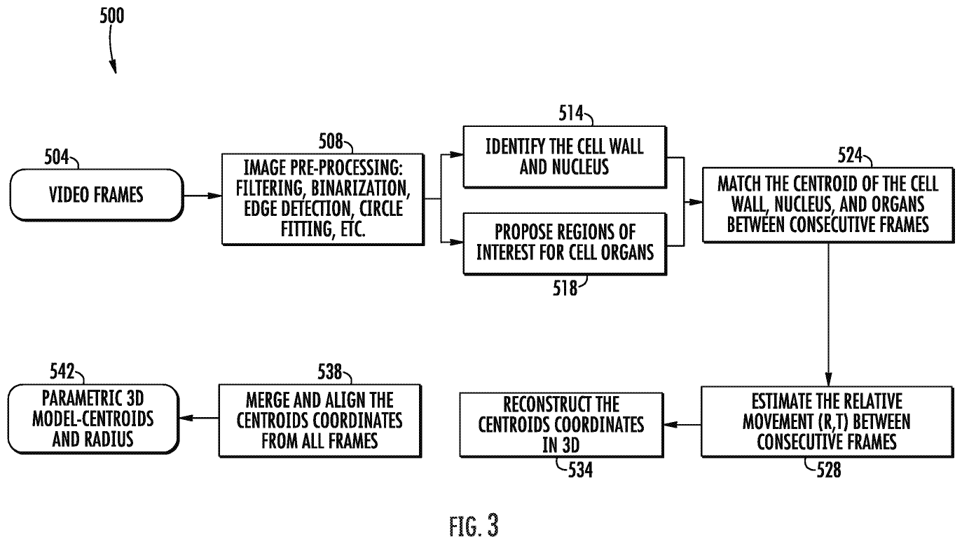

FIGS. 3-8 illustrate one example process by which the 3D volumetric image may be generated based upon a combination of the brightfield image representing the morphological information in the spectral image(s) identifying different internal structures of the particle or cell by color. FIG. 3 is a flow diagram of an example three-dimensional volumetric modeling method 500. Method 500 may be carried out by any of the image generators of this disclosure or similar image generators to produce 3D volumetric images of a particle, such as a cell. As indicated by block 504, a controller, such as image generator 160, receives video frames or two-dimensional images captured by the imager/camera 60 during rotation of particle 40. As indicated by block 508, various preprocessing actions are taken with respect to each of the received two-dimensional image video frames. Such preprocessing may include filtering, binarization, edge detection, circle fitting and the like.

As indicated by block 514, utilizing such edge detection, circle fitting and the like, image generator 160 retrieves and consults a predefined three-dimensional volumetric template of the particle 40, to identify various internal structures of the particle are various internal points in the particle. The three-dimensional volumetric template may identify the shape, size and general expected position of internal structures which may then be matched to those of the two-dimensional images taken at the different angles. For example, a single cell may have a three-dimensional volumetric template comprising a sphere having a centroid and a radius, or ellipsoid with a centroid and two radius. The three-dimensional location of the centroid and radius are determined by analyzing multiple two-dimensional images taken at different angles.

Based upon a centroid and radius of the biological particle or cell, image generator 160 may model in three-dimensional space the size and internal depth/location of internal structures, such as the nucleus and organelles. For example, with respect to cells, image generator 160 may utilize a predefined template of a cell in the spectral information from the spectral image to identify the cell wall and the nucleus. As indicated by block 518, using a predefined template in the spectral image(s), image generator 160 additionally identifies regions or points of interest, such as organs or organelles of the cell. As indicated by block 524, image generator 160 matches the centroid of the cell membrane, nucleus and organelles amongst or between the consecutive frames so as to estimate the relative movement (R, T) between the consecutive frames per block 528.

As indicated by block 534, based upon the estimated relative movement between consecutive frames, image generator 160 reconstructs the centroid coordinates in three-dimensional space. As indicated by block 538, the centroid three-dimensional coordinates reconstructed from every two frames are merged and aligned. A single copy of the same organelle is preserved. As indicated by block 542, image generator 160 outputs a three-dimensional volumetric parametric model of particle 40.

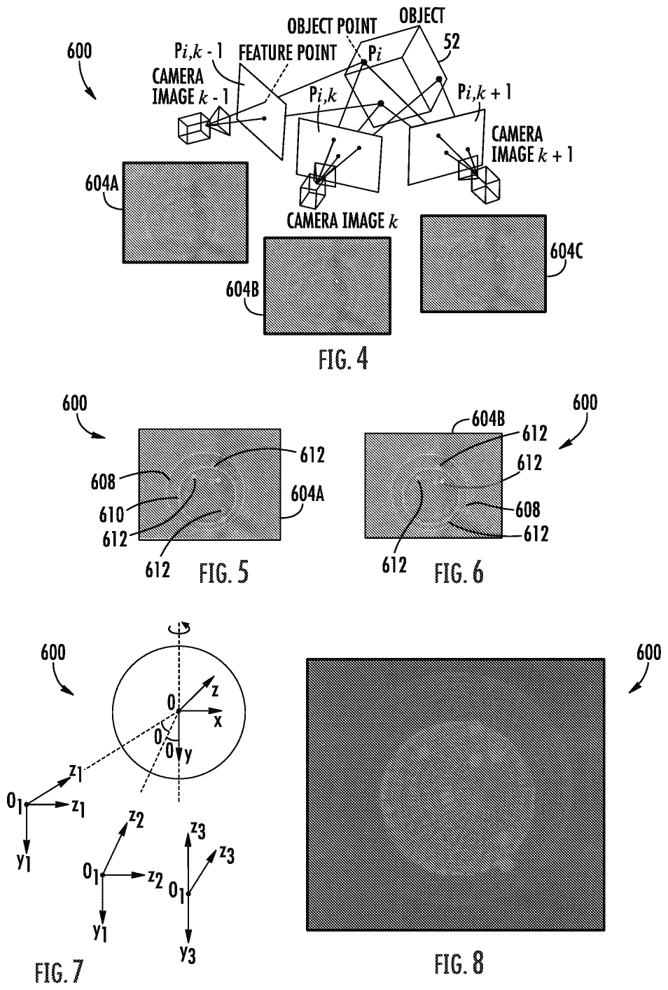

FIGS. 4-8 illustrate one example modeling process 600 that may be utilized by image generator 160 in the three-dimensional volumetric modeling of the biological particle or cell. FIGS. 6-10 illustrate an example three-dimensional volumetric modeling of an individual cell. As should be appreciated, the modeling process depicted in FIGS. 4-8 may likewise be carried out with other particles.

As shown by FIG. 4, two-dimensional video/camera images or frames 604A, 604B and 604C (collectively referred to as frame 604) of the biological particle 40 (schematically illustrated) are captured at different angles during rotation of particle 40. In one implementation, the frame rate of the imager or camera is chosen such as the particle is to rotate no more than 5° per frame by no less than 0.1°. In one implementation, a single camera captures each of the three frames during rotation of particle 40 (schematically illustrated with three instances of the same camera at different angular positions about particle 40) in other implementations, multiple cameras may be utilized.

As shown by FIGS. 5 and 6, after image preprocessing set forth in block 508 in FIG. 3, edge detection, circle fitting another feature detection techniques are utilized to distinguish between distinct structures on the surface and within particle 40, wherein the structures are further identified through the use of a predefined template for the particle 40. For the example cell, image generator 160 identifies wall 608, its nucleus 610 and internal points of interest, such as cell organs or organelles 612 in each of the frames (two of which are shown by FIGS. 5 and 6).

As shown by FIG. 7 and as described above with respect to blocks 524-538, image generator 160 matches a centroid of a cell membrane, nucleus and organelles between consecutive frames, such as between frame 604A and 604B. Image generator 160 further estimates a relative movement between the consecutive frames, reconstructs a centroid's coordinates in three-dimensional space and then utilizes the reconstructed centroid coordinates to merge and align the centroid coordinates from all of the frames. The relationship for the relative movement parameters R and T is derived assuming that the rotation axis is kept still and the speed is constant all the time. Then, just the rotation speed is utilized to determine R and T (\vec{O₁O₂}), as shown in FIG. 7, where:

$$\vec{{O}_{1} {O}_{2}} = \vec{{OO}_{1}} \cdot {R}_{θ} - \vec{{OO}_{1}} ; {R}_{θ} = {R}_{y} ( Θ ) = [ \begin{matrix}cos Θ & 0 & sin Θ \\ 0 & 1 & 1 \\ - sin Θ & 1 & cos Θ\end{matrix} ]$$

based on the following assumptions:

θ is constant;

|\vec{OO₁}|=|\vec{OO₂}|=|\vec{OO₃}|=. . . ;

rotation axis doesn't change (along y axis); and

\vec{OO₁} is known.

As shown by FIG. 8, the above reconstruction by image generator 160 results in the output of a parametric three-dimensional volumetric model of the particle 40, shown as a cell. As should be appreciated, in other implementations, the three-dimensional volumetric model or image of the particle 40 may be generated from the combination of the brightfield image and the spectral images using other methods.

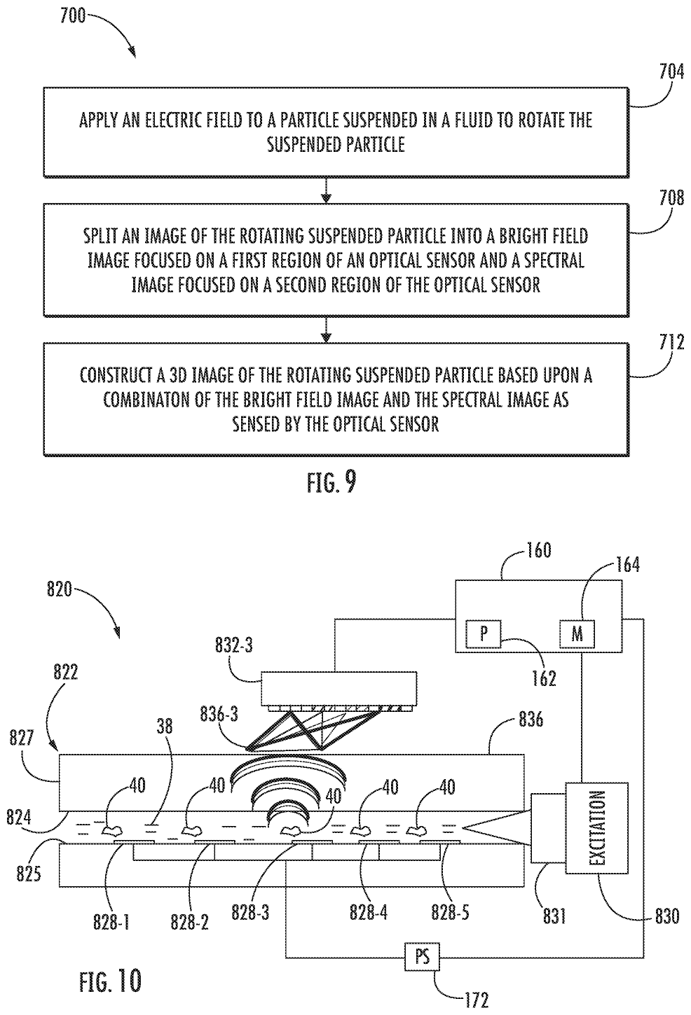

FIG. 9 is a flow diagram illustrating portions of an example particle imaging method 700. Method 700 may be well-suited to the imaging of nonbiological particles, and biological particles in the form of cellular structures such as cells, 3D cultures and organoids. The example particle imaging systems, methods and machine readable mediums facilitate the construction of 3D volumetric images of the particles to facilitate identification of further study of the particles. Although method 700 is illustrated in the context of being carried out by imaging system 120 described above, in other implementations, method 700 may likewise be carried out by the imaging system described hereafter or by similar imaging systems.

As indicated by block 704, an electric field is applied to a particle 40 suspended in a fluid 38 to rotate the suspended particle 40. A description of the applied electric field which may be used to rotate the suspended particle 40 is described above with respect to particle rotation instructions 168 and power supply 172.

As indicated by block 708, an image of the rotating suspended particle 40 is split into a brightfield image focused on a first region of an optical sensor 32 and a spectral image focused on a second region of the optical sensor 32. As described above, the splitting of the image may be carried out by a diffraction element adjacent or proximate to the volume 24 contained in the fluid 38 and rotating suspended particle 40.

As indicated by block 712, image generator 160 generates or constructs a 3D image of the rotating suspended particle 40 based upon a combination of the brightfield image and the spectral image as sensed by the optical sensor 32. As described above with respect to FIGS. 3-8, in one implementation, the spectral image is used to identify and demarcate internal structures of the particle or cell based upon color. In some implementations, different structures may be stained with different colors. The different spectral images contain differently colored structures or organelles. The brightfield image provides morphological information regarding the shape of such structures. The process set forth in FIG. 3 use both types of information to generate a 3D image, depicting internal structures of the particle.

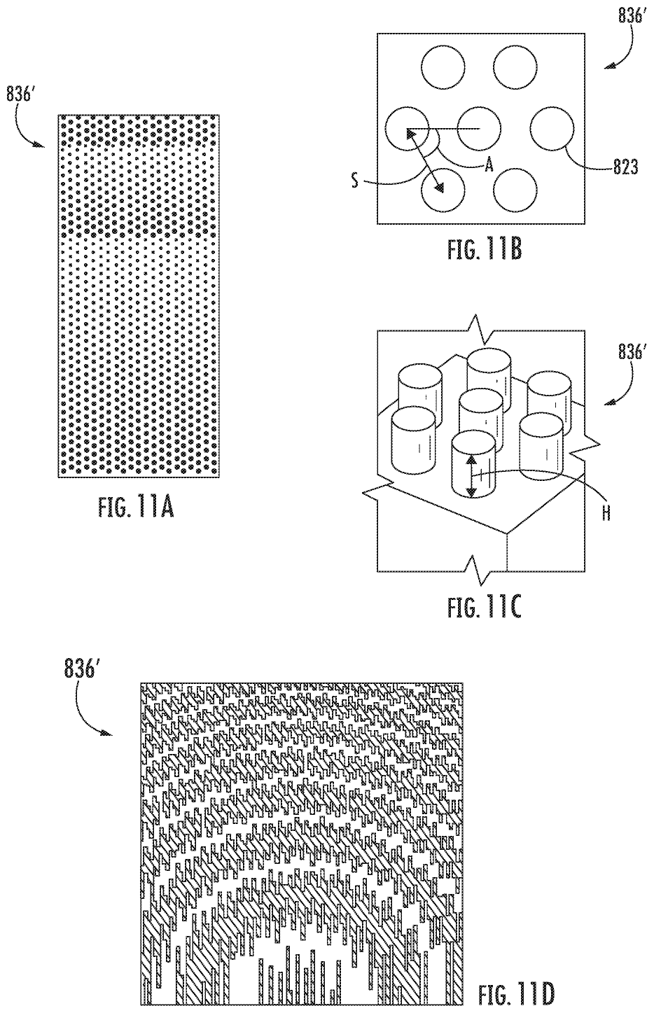

FIG. 10 schematically illustrates portions of an example particle imaging system 820. Imaging system 820 may be in the form of a spectral microscope. Imaging system 820 comprises a transparent chip 822, excitation source 830, optical sensor 832-3 and image generator 160 (described above). Transparent chip 822 comprises a chip which comprises volume 824, electrodes 828-1, 828-2, 828-3, 828-4 and 828-5 (collectively referred to as electrodes 828) and diffraction element 836-3. Volume 824 comprises a channel 825 formed within a body 827 of transparent material. In one implementation, body 827 may be formed from a fused silica. In another implementation, body 827 may be formed from fused quartz, glass, a transparent polymer or other types of transparent material that allow light to pass through body 27 and through diffraction element 836 to optical sensor 832.

Electrodes 828 are similar to electrodes 28 described above. Each of electrodes 828 is appropriately charged at a frequency so as to form a nonrotating nonuniform electric field that is to apply a dielectric torque to a corresponding proximate particle 40. Although chip 822 is illustrated as including five electrodes 828, in other implementations, chip 822 may include a greater or fewer of such electrodes 828. In the example illustrated, electrode 828-3 is illustrated as having a corresponding diffraction element 836-3 and a corresponding optical sensor 832-3. Although not illustrated in FIG. 10 for purposes of clarity, it should be appreciated that each of the electrodes 828 similarly have a corresponding diffraction element 836-3 and a corresponding optical sensor 832. The functions described with respect to diffraction element 836-3 and optical sensor 832-3 equally apply to the other diffraction elements and optical sensors associated with the other electrodes.

In one implementation, the nonrotating nonuniform electric field is an alternating current electric field having a frequency of at least 30 kHz and no greater than 500 kHz. In one implementation, the nonrotating nonuniform electric field has a voltage of at least 0.1 V rms and no greater than 100 V rms. Between taking consecutive images with sensor 832, the particle may be rotated a distance that at least equals to the diffraction limit dlim of the imaging optics, such as diffraction element 36. The relationship between minimum rotating angle θmin, radius r and diffraction limit distance dlim is θmin=dlim/r. For example, for imaging with light of λ=500 nm and a diffraction element 36 of 0.5 numerical aperture (NA), the diffraction limit dlim=λ/(2NA)=500 nm. In the meanwhile, the particle 40 may not rotate too much that there is no overlap between consecutive image frames. In one implementation, the maximum rotating angle between consecutive images θmax=180−θmin. In one implementation, the nonuniform nonrotating electric field produces a dielectrophoretic torque on the particle so as to rotate the particle at a speed such that the optical sensor 832 may capture images every 2.4 degrees while producing output in a reasonably timely manner. In one implementation where the capture speed of the optical sensor 832 is 30 frames per second, the produced dielectrophoretic torque rotates the particle at a rotational speed of at least 12 rpm and no greater than 180 rpm. In one implementation, the produced dielectrophoretic torque rotates the particle at least one pixel shift between adjacent frames, but where the picture shift is not so great so as to not be captured by the optical sensor 832-3. In other implementations, particle 40 may be rotated at other rotational speeds.

Diffraction element 836-3 is associated with electrode 828-3 and optical sensor 832-3. Diffraction element 836-3 is similar to diffraction element 36 described above. In the example illustrated, diffraction element 836 comprises a planar diffraction element. In one implementation, diffraction element 836 comprises a multifocal lens or a grating. In one implementation, diffraction on 836 comprises a planar diffraction multifocal lens in the form of a meta lens or zone plate. Each of the other diffraction elements associated with the other electrodes 828 and optical sensors 832 may be similar to diffraction 836-3.

FIGS. 11A, 11B and 11C illustrate portions of one example diffraction element in the form of a meta lens 836′. Meta lens 836′ comprises a planar diffraction element made of method material such as an ultra-thin array of tiny waveguides that bend light. FIG. 11A is an enlarged top view of meta lens 836′. FIGS. 11B and 11C are greatly enlarged views of a portion of the meta lens 836′ shown in FIG. 11A. As shown by FIG. 11B and 11C, in one implementation, meta lens 836′may be formed from TiO₂ pillars 823. Such pillars have a high refractive index, low absorption, broadband wavelength range and low roughness. In other implementations, such pillars may be formed from other materials having similar properties, such as amorphous silicon. The example meta lens 836′ has a phase that is sampled at least three times across a 2 π phase range and up to hundreds of times. As a result, a focusing efficiency as high as 80% to 90% is achieved having minimum feature size in the 50 to 100 nm range. Phase sampling is achieved with pillars of different diameters. In one implementation, the pillars 823 are in the form of cylindrical nano-resonators with a hexagon configuration. Each pillar, form from a material such as TiO₂ has a height h of approximately 400 nm, a center-to-center spacing S of approximately 325 nm and an angle A approximate 60°. In other implementations, meta lens 836′ may have other constructions.

FIG. 12 is a top view illustrating portions of an example diffraction element in the form of a zone plate 836′. With the zone plate 836″, the phase is sampled at two levels (0, π). As a result, fabrication is simplified due to the larger minimum feature size. However, the lens efficiency may be worse (below 40%). Such a zone plate may be fabricated with e-beam lithography out of a low-absorbent material such as polydimethy siloxane (PDMS). In other implementations, zone plate 836′ may have other constructions.

As shown by FIG. 10, excitation source 830 supplies electromagnetic radiation to excite a signal of selected particles 40 suspended within fluid 38 within channel 824. In one implementation, the signal may be a fluorescent signal (light emitted) from a particle 40 as a result of the particle 40 absorbing light from excitation source 830. For purposes of this disclosure, fluorescent excitation refers to a particle receiving light at a particular wavelength and subsequently emitting light at another wavelength.

In one implementation, excitation source 830 comprises a light-emitting diode that emits light that is directed towards particle 40 in channel 824. The light-emitting diode may operate across a visible range (400 to 700 nm, ultraviolet range (10 to 400 nm) and/or an infrared range (1 mm-700 nm). In one implementation, excitation source 820 may comprise a laser. For purposes of this disclosure, laser may be a device that emits light through optical amplification based on stimulated emission of electromagnetic radiation.

In one implementation, excitation source 830 has a light intensity sufficiently strong to produce fluorescent excitation of a fluorescent signal of a particle 40 to be imaged by one of optical sensors 832. In one implementation, excitation source 830 may comprise a light source in the form of an LED with a power of at least 100 mW. In another implementation, excitation source 830 may be in the form of a laser with a power of at least 1 mW. In yet other implementations, excitation source 830 may comprise a light source with a higher or lower power. Although illustrated as focusing light with an external lens 831, in other implementations, chip 822 may incorporate a lens 831 for focusing the light from excitation source 830. In some implementations, excitation source 830 may transmit light through portions of chip 822 in directions nonparallel to channel 824 or through a lens 831 and through portions of chip 822 in directions nonparallel to channel 824.

The light intensity of excitation source 830 may be selected depending upon a variety of factors such as the type of fluid 38 within channel 824, the type of particle 40 being imaged, the efficiency of refractive elements 836, the type of material of body 827 of chip 822 and the sensitivity of the optical sensors 832. For example, the light intensity of excitation source 830 may be 1 mW for an LED light source when particle 40 is a red blood cell with a selectively attached fluorophore and may be 2 mW when the particle 40 is a red blood cell with a differently selected attached fluorophore. A fluorophore may be a fluorescent chemical compound that can re-emit light upon light excitation, wherein a particular fluorophore may be attached to certain particles 40 to function as a marker.

As shown by FIG. 10, optical sensor 832-3 is associated with an edge of electrode 828-3 and diffraction element 836-3. Optics sensor 832 is similar to optical sensor 32 described above. In the example illustrated, optical sensor 832-3 comprises a CMOS array having different distinct regions or pixels which may be excited by light or photons. In other implementations, sensor 832-3 may comprise a charge coupled device (CCD). In still other implementations, optical sensor 832-3 (as well as the other optical sensors associated with the other electrodes 828) may comprise other forms of optical sensors.

Although not illustrated in FIG. 10 so as to not obscure details of the illustrated example, transparent chip 822 may comprise a plurality of channels 824 in body 827. Each of such channels may include electrodes 828 which are each associated with the diffraction element 836 and an optical sensor 832.

Image generator 160 is described above. In the example illustrated in FIG. 10, image generator 160 controls the electrical charging of electrodes 828 by power source 172 to control the rate at which the particles 40 are rotated within fluid 38. Image generator 160 further receives signals from each of the optical sensors, such as optical sensor 832-3. Image generator 160 generates a three-dimensional volumetric image of each of the particles using a combination of the brightfield image and the spectral image or images emitted by the particular particle. In one implementation, image generator 160 may generate three-dimensional volumetric image following the process described above with respect to FIGS. 3-8. The three-dimensional image output by image generator 160 depicts the shape of each particular particle 40 as well as the different internal structures and shapes of each particular particle 40.

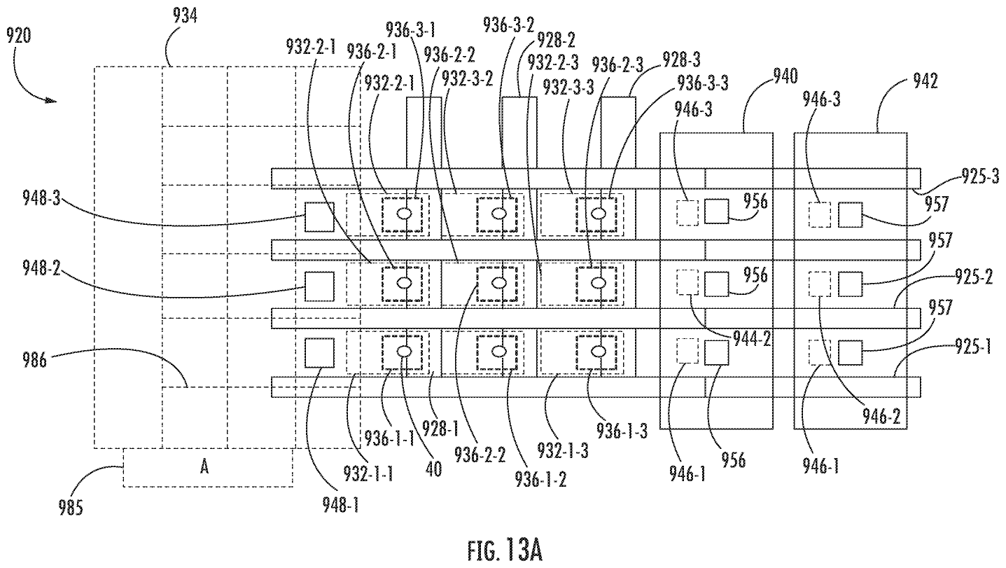

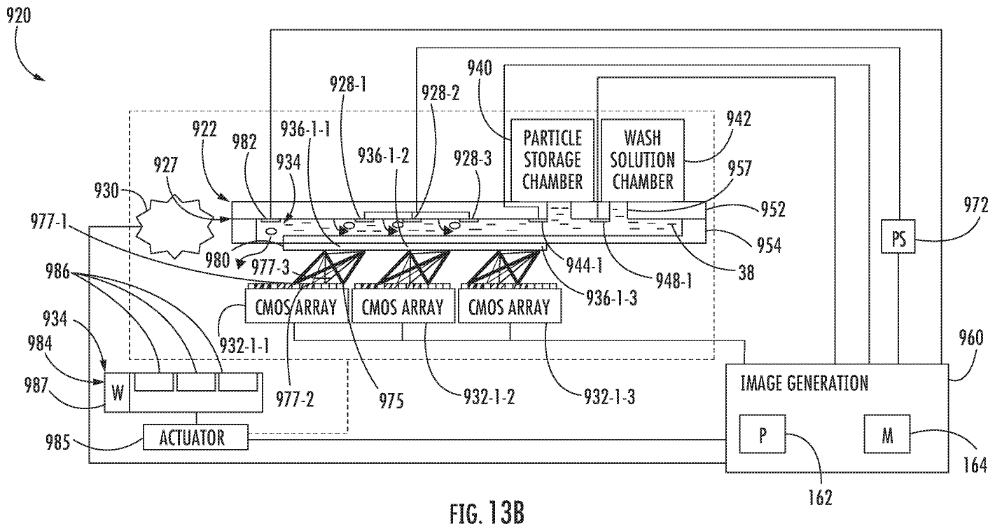

FIGS. 13A and 13B schematically illustrate portions of an example particle imaging system 920. Imaging system 920 comprises chip 922, optical sensors 932-1-1, 932-1-2, 932-1-3, 932-2-1, 932-2-2, 932-2-3, 932-1-3, 932-2-3, 932-3-3 (collectively referred to as optical sensors 932), particle receiving system 934 and image generator 960. Chip 922 comprises volumes 924, electrodes 928-1, 928-2, 928-3 (collectively referred to as electrodes 928), light sources 930, diffraction elements 936-1-1, 936-1-2, 936-1-3, 936-2-1, 936-2-2, 936-2-3, 936-1-3, 936-2-3, 936-3-3 (collectively referred to as diffraction elements 936), particle storage chamber 940, wash solution chamber 942, fluid pumps 944-1, 944-2, 944-3 (collectively referred to as fluid pumps 944), 946-1, 946-2, 946-3 (collectively referred to as fluid pumps 946) and fluid ejectors 948-1, 948-2, 948-3 (collectively referred to as fluid ejectors 948).

Volumes 924 comprise channels 925-1, 925-2 and 925-3 (collectively referred to as channels 925) (shown in FIG. 13A) formed in body 927. In one implementation, body 927 comprises a substrate 952 upon which electronic circuitry is formed and a channel layer 954 deposited on substrate. Substrate 952 may comprise material such as silicon, a ceramic, a polymer, glass or the like. As shown by FIG. 13B, substrate 952 comprises inlet ports 956 connecting each of channels 925 to particle storage chamber 940 and inlet ports 957 connecting each of channels 925 to wash solution chamber 942. Substrate 952 further supports portions of fluid ejectors 948 and fluid pumps 944. Although not specifically illustrated, substrate 952 may include electronic circuitry such as transistors and the like to facilitate the controlled supply of electrical current to fluid ejectors 948 and fluid pumps 944.

Channel layer 954 may comprise a transparent material upon which diffraction elements 936 are formed. In one implementation, channel layer 954 may be formed from the photoresist epoxy such as SU8. In other implementations, channel layer 954 may be formed from transparent polymers, glass or other transparent materials. In some implementations, channel layer 954 may be formed from a non-transparent material, wherein windows having transparent panes are formed in the non-transparent material for the propagation of light therethrough to optical sensors 932.

Electrodes 928 are each similar to electrode 28 or 828 described above. Electrodes 928 are connected to power source 972 under the control of controller 960. Electrodes 928 cooperate to apply a nonrotating nonuniform electric field so as to apply a dielectrophoretic torque to the particle 40 to rotate the particle 40 while the particle 40 is suspended in fluid within the particular channel 925. Although system 920 is illustrated as comprising three electrodes that each span all three channels 925, in other implementations, system 920 may include different sets of electrodes for different channels 925. Although system 920 is illustrated as comprising three electrodes, in other implementations, system 920 may include a greater or fewer of such electrodes as well as a greater or fewer number of optical sensors 932 and diffraction elements 936.

In one implementation, the nonrotating nonuniform electric field is an alternating current electric field having a frequency of at least 30 kHz and no greater than 500 kHz. In one implementation, the nonrotating nonuniform electric field has a voltage of at least 0.1 V rms and no greater than 100 V rms. Between taking consecutive images without sensor 32, the particle may be rotated a distance that at least equals to the diffraction limit dlim of the imaging optics, such as diffraction element 936. The relationship between minimum rotating angle θmin, radius r and diffraction limit distance dlim is θmin=dlim/r. For example, for imaging with light of λ=500 nm and a diffraction element 36 of 0.5 numerical aperture (NA), the diffraction limit dlim=λ/(2NA)=500 nm. In the meanwhile, the particle 40 may not rotate too much that there is no overlap between consecutive image frames. In one implementation, the maximum rotating angle between consecutive images θmax=180−θmin. In one implementation, the nonuniform nonrotating electric field produces a dielectrophoretic torque on the particle so as to rotate the particle at a speed such that the optical sensor 932 may capture images every 2.4 degrees while producing output in a reasonably timely manner. In one implementation where the capture speed of the optical sensor 932 is 30 frames per second, the produced dielectrophoretic torque rotates the particle at a rotational speed of at least 12 rpm and no greater than 180 rpm. In one implementation, the produced dielectrophoretic torque rotates the particle at least one pixel shift between adjacent frames, but where the picture shift is not so great so as to not be captured by the optical sensor 932. In other implementations, particle 40 may be rotated at other rotational speeds.

Light sources 930 comprise sources of light for each of channels 925 to excite or illuminate the particles 40 within each of channels 925. In one implementation, light source 930 comprise an array of LED lights. In other implementation, light source 930 may comprise lasers. In yet other implementations, light source 930 may comprise other light emitting devices. Although illustrated as transmitting light in a general direction parallel to the centerline of each of channels 925, light sources 930 may transmit light through transparent portions of body 927.

Diffraction elements 936 are similar to diffraction elements 36 and 836 described above. Diffraction elements 936 split an image of the rotating suspended particle 40, within their respective channels 925, into a brightfield image that is focused on a first region of the associated optical sensor 932 and multiple different spectral images focused on other different regions of the associated optical sensor 932. As shown by FIG. 13B, in the example illustrated, each of diffraction elements 936 focus a brightfield image on a first portion or region 975 of its associated optical sensor 932 and three different spectral images (different spectral color components of the primary image from which the spectral images and brightfield images were derived) onto regions 977-1, 977-2 and 977-3 of the same optical sensor 932.

Particle storage chamber 940 comprises a reservoir or chamber for temporarily storing a fluid are solution potentially containing particles of interest for analysis. In one implementation, particle storage chamber 940 is formed in substrate 952. In other implementations, chamber 940 may be mounted or joined to substrate 952. In some implementations, chip 922 may be removably inserted into a larger unit providing light sources 930, optical sensors 932, image generator 960 and/or chambers 940, 942. Chamber 940 supplies the fluid containing particles of interest through an associated one of ports 956.

Wash solution chamber 942 comprise a reservoir chamber for temporally storing a wash solution that has a chemical composition for cleaning and removing particles from each of channels 925 to ready each of channels 925 for a subsequent flow of fluid from chamber 940 for analysis. In one implementation, wash solution chamber 942 is formed in substrate 952. In other implementations, chamber 952 may be monitored or joined to substrate 952. Chamber 942 supplies a wash solution through an associated one of ports 957.

Fluid pumps 944 comprise pumps to move or draw fluid from chamber 940 and along its respective channel 925. In the example illustrated, each of fluid pumps 944 comprises an inertial pump. In the example illustrated, each of pumps 944 comprises a thermal resistor supported by substrate 952 adjacent to a respective port 956. The thermal resistor is heated to a temperature above the nucleation temperature of the fluid so as to form a bubble. Formation and subsequent collapse of such bubble may generate flow of the fluid. As will be appreciated, asymmetries of the expansion-collapse cycle for a bubble may generate such flow for fluid pumping, where such pumping may be referred to as “inertial pumping.” In other implementations, other fluid pumps may be used.

Fluid pumps 946 are similar to fluid pumps 944 except that fluid pumps 946 move or draw fluid from chamber 942 and along its respective channel 925. In the example illustrated, each of fluid pumps 946 comprises an inertial pump for inertial pumping. In the example illustrated, each of pumps 944 comprises a thermal resistor supported by substrate 952 adjacent to a respective port 957. In other implementations, other forms of fluid pumps may be used.

Fluid ejectors 948 are used to controllably eject fluid from channels 925. In the example illustrated, each of fluid ejectors 948 comprises an ejection port 980 and a fluid actuator 982. Ejection port 980 is formed through channel layer 954. Each of fluid actuators 982 comprises an electrically driven fluid actuator supported by substrate 952 that controllably displaces fluid within its respective channel 925 through ejection port 980. Each of fluid actuators 982 may comprise a thermal resistive fluid actuator, a piezo-membrane based actuator, and electrostatic membrane actuator, mechanical/impact driven membrane actuator, a magnetostrictive drive actuator, and electrochemical actuator, and external laser actuators (that form a bubble through boiling with a laser beam), other such microdevices, or any combination thereof. In the example illustrated, each of fluid actuators 982 comprises a thermal resistor for serving as a thermal resistive fluid actuator.

Optical sensors 932 are each similar to optical sensors 32 and 832 described above. In the example illustrated, each of optical sensors 932 comprises a CMOS array. In other implementations, each of optical sensors 922 may comprise a CCD or other optical sensing device. Each of optics sensors 922 has different regions, such as regions 975 and 977 for receiving the focused brightfield images and spectral images and for outputting signals representing such brightfield images and spectral images.

Particle receiving system 934 receives, stores and separates the different particles 40 for which image data has been acquired. Particle receiving system 934 receives such particles through ejection orifice 980. In the example illustrated, particle receiving system 934 comprises a two-dimensional multi well plate 984 and an actuator 985. Plate 984 comprises a two-dimensional array of wells 986 which may receive individual particles or multiple particles of the same type or classification. In the example illustrated, plate 984 further comprises a waste well or chamber 987 for receiving wash solution and other waste being ejected from the channels 925

Actuator 985 comprises a mechanism to selectively position plate 984 and its wells 986, 987 relative to ejection port 980 for receiving a particle 40 or multiple particles 40. In one implementation, actuator 985 is operably coupled to plate 984 to controllably position plate 984 in two dimensions to selectively position a particular one of wells 986 or well 987 for receiving a particle 40 ejected through orifice 980. In one implementation, actuator 985 comprises linear actuators in two dimensions such as electrically driven solenoids, hydraulic or pneumatic cylinders or motors. As indicated by broken lines, in other implementations, actuator 985 may be operably coupled to chip 922 or a carrier of chip 922 to position orifice 980 with respect to a particular underlying well 986 or well 987. Actuator 985 operates under the control of image generator 960.

Image generator 960 is similar to image generator 160 described above except that image generator 960 additionally controls pumps 944, 946, ejectors 982 and actuator 985 to control the flow of fluid and particles through channels 925. Following instructions contained in medium 164, processor 162 outputs control signals to the pump 944 to move fluid from particle storage chamber 940 into and along its respective channel 925. Image generator 960 further outputs control signals to power source 972 to charge electrode 928 so as to attract, retain and spin the particle of interest within the respective channel 925. At the same time, image generator 960 outputs control signals to light source 930 to illuminate or excite the particle as it is being rotated. During such rotation, the associated or aligned optical sensor 932 captures the brightfield image and the spectral images output by the associated diffusion elements 936. Signals representing the brightfield image and the diffraction images are transmitted to image generator 960. Image generator 960 may use a brightfield images and the spectral images to form a 3D volumetric image of the particle as described above with respect to FIGS. 3-8.

The image or the data resulting from such images may be further used to identify or classify the particle. Based upon the image, identification or classification of the particle, image generator 960 causes actuator 985 to selectively position plate 984 opposite to ejection orifice 980. Image generator 960 output signals causing actuator 985 to eject the identified particle into a predetermined one of wells 986. Image generator 960 may store the particular location, the particular well 986 in which the particular identified or classified particle resides, after being ejected into the particular well 986. This general process may be carried out for each of channels 925 concurrently, resulting in efficient identification, classification and/or imaging of large numbers of particles.

At certain points in time, image generator 960 may output signals causing a pump or multiple pumps 946 to draw and move wash solution from chamber 942 along channel 925 or multiple channels 925. The wash solution may remove contaminants or remaining particles from prior processes. During such a wash process, image generator 960 may control actuator 985 to position waste well 986 opposite to ejection orifice 980, wherein image generator 960 actuates fluid actuator 92 to eject the wash solution through orifice 980 into the waste well 987. As a result, system 920 is once again ready for a new batch of particles from a potentially different solution supplied through chamber 940.

System 1020 may be utilized to image biological particles such as cells. In one such example mode of operation, initial pumps 944, in the form of thermal resistors, fire and load cell containing solution from chamber 940 into channels 925. An electric field is applied by electrodes 928, wherein the electric field attracts and retains the cells of interest in place relative to the electrodes 928. An appropriate frequency is then applied to cause the cells to spin. The frequency may be based upon an estimated cell membrane capacitance, cytoplasm conductivity and surrounding solution conductivity. The cells are then illuminated with light source 930 and then imaged via diffraction elements 936 on two different regions of respective optical sensors 932. Image generator 960 processes the brightfield images and the spectral images from the different regions of the optical sensors 9322 reconstructed 3D image for each of the individual cells. Following such imaging, the electric field applied by electrodes 928 is discontinued, releasing the image cells back into the solution within the channels 925. As such time, and appropriate well of multi well plate 984 is brought under each of the respective orifices 980, wherein the cells are then ejected by fluid actuators 948, bringing new sales from chamber 940 into the respective channels 925. This cycle may be repeated until all the cells are processed or sufficient data has been collected.

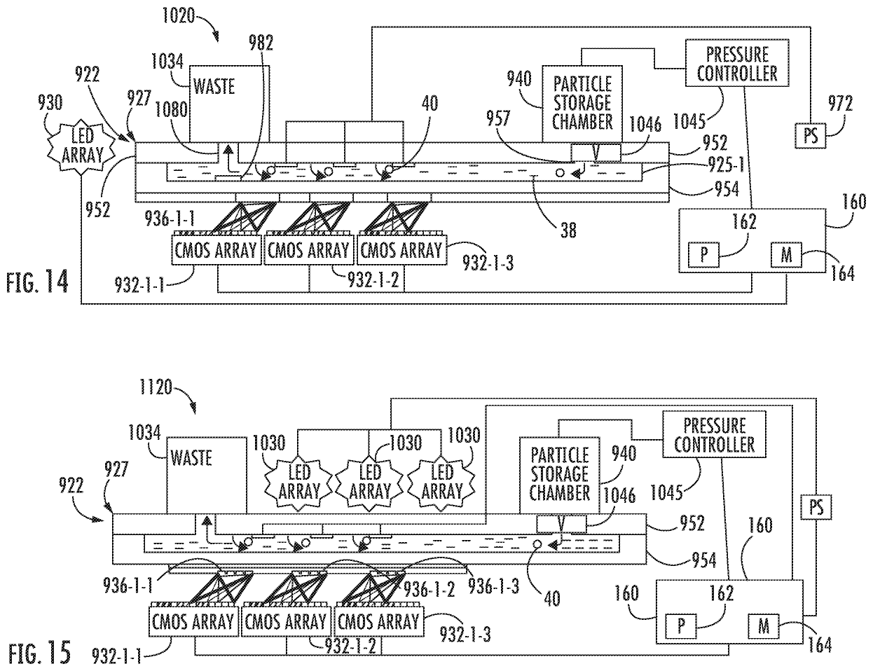

FIG. 14 is a sectional view schematically illustrating portions of an example particle imaging system 1020. Imaging system 1020 is similar to imaging system 920 described above except that imaging system 1020 provides a waste reservoir 1034 directly connected to each of channels 925 and controls the supply of the particle containing solution or fluid from chamber 940 with a pressure controller 1045 and a valve 1046. Those remaining components of system 1020 which correspond to components of system 920 are numbered similarly and/or are shown in FIGS. 13A and 13B.

Waste reservoir 1034 is similar waste well 934 described above except that waste reservoir 1034 directly connected to outlet ports 1080 of each of channels 925. In one implementation, waste reservoir 1034 is formed as part of substrate 952. In another implementation, reservoir 1034 is bonded or otherwise affixed to body 927 of chip 922. In yet other implementations, waste reservoir 1034 may be a separate component having a port which is aligned with port 1080 and sealed about port 1080. For example, in one implementation, chip 922 may be removably positioned within a larger unit providing particle storage chamber 940, waste reservoir 1034, light source 930 and/or optical sensors 932. Waste reservoir 1034 receives the fluid and particles 40 after the particles have been imaged as described above.

Pressure controller 1045 and valve 1046 control the supply of the particle containing fluid 38. Pressure 1045 comprises a pump or other device which controls the pressure of the fluid within chamber 940. Pressure controller 1045 operates in response to control signals from image generator 160.

Valve 1046 selectively control the size of its respective port 957 in response to control signals from imaged generator 160. The example illustrated, each of the ports 957 for each of the channels 925 has the assigned valve 1046, facilitating individual control the supply of part of containing fluid 38 to each of the individual channels, independent of one another. In some implementations, pressure controller 1045 and such are valve 1046 may be omitted. In some implementations, as indicated by broken lines, chip 922 may additionally comprise a fluid actuator 982 (described above) for selectively ejecting fluid through port 1080 into waste reservoir 1034.

FIG. 15 is a sectional view schematically illustrating portions of an example particle imaging system 1120. System 1120 is similar to system 1020 described above except that system 1120 comprises light sources 1030 in place of light source 930. Those remaining components of system 1120 which correspond to components of system 920 are numbered similarly and/or are shown in FIGS. 13A, 13B and 14.

Light sources 1030 are similar light source 930 described above except that light sources 1030 propagate light in directions perpendicular to chip 922, through a transparent portions of substrate 952. In the example illustrated, independent and distinct light sources 1030 are associated with each of the different electrodes 928, facilitating different levels of excitation or the mission of different wavelengths of light at each of the three different sensing stations provided by the different electrodes within each of channels 925. In some implementations, independent and distinct light sources 1030 are provided for each of the optical sensors 932 such that each individual particle 40 may be illuminated are excited in a different manner (each of the nine particles 40 shown in FIG. 13A may be differently excited or illuminated at one time).

Although the present disclosure has been described with reference to example implementations, workers skilled in the art will recognize that changes may be made in form and detail without departing from the scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A particle imaging system comprising:
a volume to contain a fluid having a suspended particle;
electrodes proximate to the volume to apply an electric field to rotate the suspended particle;
an optical sensor comprising a first region and a second region; and
a diffraction element to split an image of the suspended particle into a brightfield image focused on the first region and a spectral image focused on the second region.

2. The particle imaging system of claim 1, wherein the optical sensor comprises a third region, wherein the diffraction element is to further split the image of the suspended particle into a second spectral image, of a different wavelength than the spectral image, focused on the third region.

3. The particle imaging system of claim 1, wherein the diffraction element has a phase profile including an axial focus to focus the brightfield image onto the first region and an oblique focus to focus the spectral image onto the second region.

4. The particle imaging system of claim 3, wherein the oblique focus has a lateral offset that increases with increasing wavelength.

5. The particle imaging system of claim 1 further comprising a light source directed at the volume.

6. The particle imaging system of claim 1 further comprising an image generator to output a 3D image of the suspended particle containing both morphological and spectral information, based upon signals from the first region and the second region of the optical sensor.

7. The particle imaging system of claim 1, wherein the diffraction element is selected from a group of diffraction elements consisting of: a multifocal lens, a grating and a prism

8. The particle imaging system of claim 1, wherein the diffraction element comprises a planar diffraction element selected from a group of planar diffraction elements consisting of a multifocal lens and a grating.

9. The particle imaging system of claim 1, wherein the diffraction element comprises a multifocal lens selected from a group of multifocal lenses consisting of a meta lens and a zone plate.

10. The particle imaging system of claim 1 further comprising:
a fluid ejector; and
a multi well plate, wherein the fluid ejector is selectively actuatable to selectively eject the suspended particle into a particular well of the multi well plate.

11. The particle imaging system of claim 1 further comprising a substrate forming a fluid channel providing the volume, wherein the electrodes and the diffraction element are supported by the substrate.

12. The particle imaging system of claim 1, wherein the optical sensor comprises a CMOS array.

13. A particle imaging method comprising:
applying an electric field to a particle suspended in a fluid to rotate the suspended particle;
splitting an image of the rotating suspended particle into a brightfield image focused on a first region of an optical sensor and a spectral image focused on a second region of an optical sensor; and
constructing a 3D image of the rotating suspended particle based upon a combination of the brightfield image and the spectral image as sensed by the optical sensor.

14. The method of claim 13, wherein the particle suspended in the fluid in a fluid volume provided by a substrate, wherein the image of the rotating suspended particle is split into the brightfield image in the spectral image with a planar diffraction element supported by the substrate and wherein the optical sensor comprises a CMOS array supported by the substrate.

15. A non-transitory machine-readable medium containing instructions to be followed by a processor, the instructions comprising:
particle rotation instructions to direct the processor to electrically charged electrodes to apply an electric field to rotate a particle suspended in a fluid; and
imaging instructions to direct the processor to construct a 3D image of the particle, during rotation of the particle, from a combination of a brightfield image of the rotating suspended particle and a spectral image of the rotating suspended particle concurrently sensed.
